(19) United States
(12) Patent Application Publication
(10) Pub. No.: US 2007/0285710 A1
(43) Pub. Date: Dec. 13, 2007

(54) CONSOLIDATION OF APPLICATION DOCUMENTS FOR ELECTRONIC SUBMISSION TO A POSTAL NETWORk

(75) Inventors: Steven Patrick Cranitch, Greenslopes (AU); Russell Allen Brockhurst, Queensland (AU)

Correspondence Address: FENWICK & WEST LLP, SILICON VALLEY CENTER, 801 CALIFORNIA STREET, MOUNTAIN VIEW, CA, 94041, US

(73) Assignee: EPIP PTY LTD., West End (AU)

(21) Appl. No.: 11/758,134

(22) Filed: Jun. 5, 2007

(30) Foreign Application Priority Data
Jun. 8, 2006 (AU) 2006202430

(51) Int. Cl. G06F 3/12; G06F 15/00

(52) U.S. Cl. 358/1.15; 358/1.18

(57) ABSTRACT

An automated hybrid mail system/method (10) which sends a graphic image file (17a) from a sender's terminal (14) into a postal network (26) via a remote printing facility (24). The system/method can concatenate or consolidate a plurality of application documents into a virtual print stream for printing by producing a plurality of graphic image files (17a), each graphic image file obtained from a different application document, consolidating at least some of the plurality of graphic image files (17a) into a virtual print stream, and producing an electronic document (17), the electronic document (17) including at least the virtual print stream. The electronic document (17) is transmitted to a processing system (24) for subsequent automated printing of each graphic image file (17a) as a hardcopy document (25) by a printer (24).

### RELATED APPLICATION

This application claims the benefit under 35 U.S.C. § 119 of Australian application serial no. 2006202430, filed on Jun. 8, 2006, which application is incorporated herein in the entirety by this reference.

### TECHNICAL FIELD

The present invention relates to a method, system, computer program product and/or computer readable medium of instructions for improved delivery of electronic documents into postal networks. More particularly, a graphic image file is created at a sender's computer terminal and transmitted to a server as part of an electronic document for onward delivery to a printing device, which produces a hardcopy document version of the graphic image file for delivery to a recipient via a standard postal or mail network.

### BACKGROUND ART

U.S. application Ser. No. 11/099,205, also filed by the present assignee, is directed to an automated hybrid mail system/method which sends a graphic image file from a sender's terminal into a postal network via a remote printing facility. The system can check the recipient's address is correctly located on the graphic image file before sending and (optionally) verifying the recipient's address and adding a correct Delivery Point ID and bar code. However, the subject matter of U.S. application Ser. No. 11/099,205 does not provide a “consolidation or concatenation of documents” mode, function or feature, as hereinafter discussed, which the present invention addresses.

Definitions

‘Terminal’ means a device in a networked data or information communications system which is capable of requesting and receiving information from local or remote information sources. The capability of the terminal to request and/or receive information can be provided by an application program, hardware or other such entity. A terminal may be provided with associated devices, for example an information storage device such as a hard disk drive and a display screen. A terminal may be a computer or computerised device, a personal computer (PC), a type of mobile or cellular phone, a mobile data terminal, a portable computer, a personal digital assistant (PDA), a pager, a thin client, or any other similar type of electronic device.

‘Computer Network’ as referenced in this specification should be taken to include all forms of connected or communicating terminals having at least two terminals connected or communicating so as to be able to transfer information or data. That is, the term computer network should be taken to include any type of terminal or part thereof, as defined herein, which is rendered such that it is capable of communicating with at least one other terminal. The communication of information or data can occur over any data communications network, computer network, wireless network, inter-network, intra-network, local area network (LAN), wide area network (WAN), the Internet and developments thereof, transient or temporary network, combinations of the above or any other type of network providing for computerised, electronic or digital devices.

‘Postal Network’ means any form of network or system for distribution of physical mail, such as hardcopy documents or letters, and includes government or private postal services, a firm of couriers, or any other network or system whereby a hardcopy document can be delivered to a recipient's physical address.

‘Application Document’ means a document produced by a user on a terminal using any application program, or received by a user on a terminal. Examples of application documents include word-processing documents produced by, say, Microsoft Word, a spreadsheet, an invoice produced from an accounting package, or a document produced by a desktop publishing package.

‘Graphic Image File’ means an electronic file with graphical information that can be used to reproduce an original application document in a form whereby what the user sees on the terminal screen is the same as when the graphic image file is printed. An example of a graphic image file could be a file in Postscript, Portable Document Format (PDF), Printer Command Language (PCL) or Microsoft Enhanced Metafile Format (EMF).

‘Electronic Document’ means an electronic file that can be stored on a terminal or transmitted over a computer network.

‘Hardcopy Document’ means a document printed on paper or a similar medium.

Currently, there are known processes which result in physical delivery of a computer generated hardcopy document to an end recipient via a postal network.

Regardless by which process the hardcopy document is produced, the hardcopy document is typically placed in an envelope and delivered to a mail box, post office, or other postal collection point, for subsequent delivery of the letter (envelope and hardcopy document) by the postal network.

Manual Process

This involves manual printing of a hardcopy document at a local printer connected to a computer, and physical delivery of the printed hardcopy document to a postal collection point (i.e. local post office collection box).

Currently the vast majority of hardcopy documents are submitted to the postal network via a process of printing an application document at the point of creation of the application document, placing the printed hardcopy document in an envelope to form a letter, addressing the letter, and manually delivering this to a postal collection point. A postal organization then collects the letter from the postal collection point, sorts the letter into an area for delivery using a post code or other location indicator technique, aggregates letters for each postal centre, and then physically delivers the letter to the postal centre nearest to the recipient's address. This postal centre nearest the recipient's address then sorts the letter and delivers the letter, with the hardcopy document, to the actual recipient's address.

Significant problems are associated with the described manual process for delivery of hardcopy documents. These include:
a) It is a labour intensive process for the sender of the hardcopy document. The sender must first print the application document to create the hardcopy document, often fold the hardcopy document, insert the hardcopy document into an envelope, and physically deliver the envelope with the hardcopy document to a postal collection point.
b) The letter enters the postal network at a point close to or closest to the sender, and not the recipient.
c) The hardcopy document is unable to be tracked from creation to delivery. Currently the letter can only be tracked after lodgment at the postal collection point, i.e. there is no tracking from the point of creation to the postal collection point.
d) The sender can insert other materials, like harmful biological or chemical agents, or other hazardous material, into the letter at the source prior to physically posting.
   Outsourced Printing

This involves using pre-defined fields in a template to generate a data file to be processed by a printer. Software at a printing house uses the data file and pre-defined template to produce the final hardcopy document. Once the hardcopy document is prepared for mailing it is delivered to a postal collection point from which stage the usual postal delivery process takes place.

Outsourced printing uses a process of rendering the application document for local printing, i.e. outsourced printing relies on the process of using a template and either manually, or via a data merge process, populating the fields on a template with data. This necessitates that the printing house offering the outsourced printing facilities must manipulate the data at their premises, either by merging data, or having the sender manually complete a template with details such as the address of the recipient.

Significant problems are associated with the described outsourced printing process for delivery of hardcopy documents. These include:
a) The remote host computer at the printing house offering the outsourced printing facilities is required to have prior knowledge of the type of application document it is to be receiving. This works by having a template setup on the printing house's remote host computer, and data is input to the remote host computer for merging with the template. This process is not efficient for single application document printing, or ad hoc changes to the appearance of the application document, as the software needs to be informed about any changes so that the templates can be changed.
b) The printing house's remote host computer cannot accept application documents from a variety of different originating application programs, without having some prior knowledge of how these application documents should be formatted.
c) Outsourced printing systems work on batch processes, in that these systems need to process all the printing for one client as a batch, before printing another client's job. For example, this means that these systems cannot accept one hundred different application documents originating from unrelated clients, and process them in one batch.
d) A letter enters the postal network at a point convenient for the printing house, which is not close to or closest the recipient's address.
e) An integrated tracking and identification system from the time of creation of the application document to delivery to the recipient's address is not provided.
f) Necessarily requires filling in of templates or predefined fields.
   Use of a Printer Driver

The Adobe printer driver and PDF Transit product use client-side PDF file creation, web browser job submission, pre-configured print provider's specifications, encryption, and server-side web acceptance of files.

This process involves using a printer driver to create a type of graphic image file locally, and then send the graphic image file, via the Internet or e-mail, for remote printing. An example of this would be where a sender creates an application document in Microsoft Word, and then uses a printer driver to create an Adobe PDF format representation. The PDF could then be transmitted to a remote server which can print a hardcopy document version of the PDF. The hardcopy document can then be placed in the postal network. The sender may use email to forward the PDF, or may upload the PDF to a remote web server using a web browser or file transfer software. The process of transferring the PDF is a separate process that is initiated by the sender.

Significant problems are associated with the described printer driver process for delivery of hardcopy documents. These include:
a) The printer driver process does not track the graphic image file or hardcopy document from creation at the sender's computer until delivery. No client terminal document manager is provided to view status updates or previously sent documents.
b) The sender is not provided with a check on the position and presence of the recipient's address in the hardcopy document to be generated. Without this feature, the address may not be in the correct position for a window envelope when received by a remote printer, which would render the hardcopy document unable to be delivered as the recipient's address would not show correctly through the window of the envelope.
c) There is no extraction of address data to look-up and produce, for example, a Delivery Point Identification (DPID).
d) There is no guarantee that the application documents intended to be sent by the sender correspond to the PDF documents received by a remote computer. Because this process involves manual steps, it is possible that the sender creates an application document for sending, but inadvertently selects a different graphic image file to send or upload for remote printing.
e) The hardcopy document enters the postal network at a postal collection point which may not be close or the closest collection point to the recipient's address. There is no intelligence in this process to automatically route the PDF document based on post code or other location indicator to a printing or postal location that is closer or closest to the recipient's address.
f) The printer driver process does not handle the billing of the transaction, that is the printer driver process does not make a record of the sender and create a record to bill the sender in an automated fashion. Also there is no ability to link each electronic document with any intermediary salespeople.
g) The printer driver process does not confirm or provide an update of delivery status to the sender when printing or delivery of the hardcopy document is completed.
h) There are no server rules or document quarantine processes.
   International Publication No. WO 99/21330

A system and method for transmission of a document from a sending location to a receiving location is disclosed in International Publication No. WO99/21330. This document discloses a system and method which has several disadvantages, including, inter alia: no verification on the sender computer that the recipient's address is in a correct position for a window envelope; no extraction of recipient address data for validity checks or to look up and merge with a DPID; no ability to reposition elements of the document; no server computer forwarding rules or document quarantine processes; no client computer software for managing documents, viewing a previously sent graphic image file or status updates; and no ability to link each document with a reseller or salesperson.

This identifies a need for a method, system, computer program product and/or computer readable medium of instructions to facilitate the delivery of hardcopy documents, obtained from at least one application document, into a postal network which overcomes or at least ameliorates at least some of the aforementioned or other problems in the prior art.

### DISCLOSURE OF INVENTION

According to a first broad form, there is provided a method for printing a plurality of application documents in a virtual print stream, including: producing a plurality of graphic image files, a graphic image file obtained from an application document; concatenating/consolidating at least some of the plurality of graphic image files into a virtual print stream; producing an electronic document; and, transmitting the electronic document to a processing system for subsequent printing of the at least some of the plurality of graphic image files by at least one printer.

In a further particular example embodiment, the electronic document includes an instruction file containing printing instructions. The instruction file may also contain a unique identification number and/or a representation of the unique identification number may be printed on the hardcopy document.

According to a second broad form, there is provided a method of consolidating a plurality of application documents into a virtual print stream for printing of hardcopy documents, obtained from the plurality of application documents, including: a plurality of application documents being created on, or sent to, a client terminal; software resident on the client terminal generating a plurality of graphic image files, a graphic image file obtained from an application document, at least one graphic image file including a recipient's address; concatenating/consolidating at least some of the plurality of graphic image files into a virtual print stream; an electronic document being generated which includes at least the virtual print stream; the electronic document being transmitted to a server; and, software resident on the server receiving the electronic document and forwarding the virtual print stream to be printed by printer for subsequent entry of the printed hardcopy documents into the postal network.

According to a third broad form, there is provided a system for concatenating/consolidating a plurality of application documents into a virtual print stream for printing, the system including: a server for receiving an electronic document, the electronic document including at least a virtual print stream, the virtual print stream having been produced from a plurality of graphic image files, a graphic image file obtained from an application document; and, a printer server for receiving the virtual print stream.

According to a fourth broad form, there is provided a computer program product for concatenating/consolidating a plurality of application documents into a virtual print stream for printing, the computer program product configured to: produce a plurality of graphic image files, a graphic image file obtained from an application document; concatenate/consolidate at least some of the plurality of graphic image files into a virtual print stream; produce an electronic document, the electronic document including at least the virtual print stream; and, transmit the electronic document to a processing system for subsequent printing of each graphic image file.

It should be noted that the application document itself need not necessarily actually be produced on the client terminal, the application document could be produced elsewhere and sent to the client terminal. Also, the sender need not necessarily be the creator of the application document.

In a particular form of the invention, a representation of the unique identification number is added to the hardcopy document, for example as a bar code or magnetic code, and this representation of the unique identification number can be used to track the hardcopy document within the postal network until the hardcopy document reaches the recipient or recipient's address. Preferably, if an optical code, such as a bar code, is used the code is readable through the window of an envelope. This allows the document to be tracked from creation to delivery in both electronic and physical form.

In a further particular form, the server (or network of servers) receives notification of printing and onward delivery of the hardcopy document and updates records in a database, and/or notifies the sender of this action by electronic mail. Details of the transaction can also be recorded in the database for billing purposes.

In another embodiment, an electronic document received by the server can be quarantined on the server if a sender's account is not active, for example if the sender has not made previous payments, has no account or has no credit. An electronic notification can be sent to the client terminal alerting the sender to the electronic document having been quarantined.

Preferably, the graphic image file is routed to a printer close or closest to, or most conveniently located to, the indicated recipient's address. Also preferably, the sender is only required to instruct the client-side software to transmit the electronic document to the server, with the client-side software and/or server-side software handling further aspects of delivery into the postal network.

In various alternative forms, the position of the recipient's address in the graphic image file can be checked by:

the client-side software;

the sender, by way of the graphic image file being presented in a preview screen with a recipient address boundary mask overlayed; and/or

the server-side software rechecking the position.

In a possible embodiment, the client-side software resident on the client terminal, or the server-side software, extracts the text positioned at the location of the recipient's address area from the graphic image file and attempts to verify that the text constitutes a valid address. For example, by checking that a valid postcode or suburb name has been included. In another form of the invention, optical scanning recognition software is used to convert the recipient address component of the graphic image file to text form, which is then checked to seek to verify that the text constitutes a valid address.

According to still further aspects, the graphic image file can be checked to verify the graphic image file can be processed by a mailhouse. The checks can include: that the fonts in the graphic image file are supported by the mailhouse; an address is provided; and/or a valid address is provided according to parameters for correct addressing in the destination country. Also, the graphic image file could be moved or re-sized to allow for page barcodes, or other indicia inserted by the mailhouse.

In another form, the client-side software, or the server-side software, reads and looks up the recipient's address in a postal address file and generates an address representation, for example a barcode representation of the recipient's address or a suitable Delivery Point Identification (DPID) to facilitate transmission to an appropriate printer and/or the recipient.

In a particular embodiment, the client-side software allows the sender to preview the graphic image file and displays an overlay or mask showing the preferred location for the recipient's address. Moreover, the client-side software allows the sender to relocate or delete the graphical elements that form the graphic image file whilst in this preview mode. For example, the position of the recipient's address could be relocated if not within the preferred location. The software may also provide the sender with the option to delete components in the address area and to manually type in text indicating a correct address, which is then incorporated into the graphic image file before transmission of the electronic document to the server.

The client-side software can compress and/or encode the graphic image file into a format suitable for electronic transmission. Furthermore, according to a particular embodiment, the client-side software encrypts the electronic document using public key encryption before electronically transmitting the electronic document to the server. The electronic document can also be digitally signed.

Preferably, the server is programmed with rules that enable the server to forward the graphic image file from the received electronic document to a printer close or closest to, or most conveniently located to, the recipient's address.

According to a further particular form, in the case where the application document consists of a set of separate documents to be delivered to separate recipients—for example, the results of a mail merge job in a word-processing application—special codes are incorporated at the end and/or beginning of the mail merge template to establish the start and the end of individual application documents. This allows a large mail merge job to be separated into the individual component documents at the client terminal, which further allows the documents to be processed on the server without human intervention. Also, an analysis of the structure of each application document can be performed to determine start and end points of each of the documents or collection of documents.

In a particular embodiment, each printer may be managed by a printer server which receives the graphic image file and sends an electronic notification message back to the originating server.

In a further mode of operation, the printers are integrated into the postal network and all necessary facilities for printing, folding, inserting and lodgement of hardcopy documents into the postal network is provided.

In a particular embodiment, each printer can be managed by a server computer (or network of servers) which manages the process of receiving the graphic image files, decoding the graphic image files, and printing the hardcopy document. In another embodiment, these printer servers can be programmed with rules to forward graphic image files to other printers in the event of printer breakdown or overloading.

According to another embodiment, the system/method can be designed to operate as a multi-level distribution system/method where intermediate resellers and individual salespersons can be cross-linked to the final mailed hardcopy document and be provided with a commission based on transaction value.

### BRIEF DESCRIPTION OF FIGURES

The present invention should become better understood from the following detailed description of a preferred but non-limiting embodiment thereof, described in connection with the accompanying figures, wherein:

FIG. 1 illustrates a general system providing an embodiment of the invention;

FIG. 2 illustrates how the client terminal can query the delivery status of an electronic document;

FIG. 3 illustrates a possible billing system structure;

FIG. 4 illustrates a method of printing a plurality of application documents in a single virtual print stream.

### MODES FOR CARRYING OUT THE INVENTION

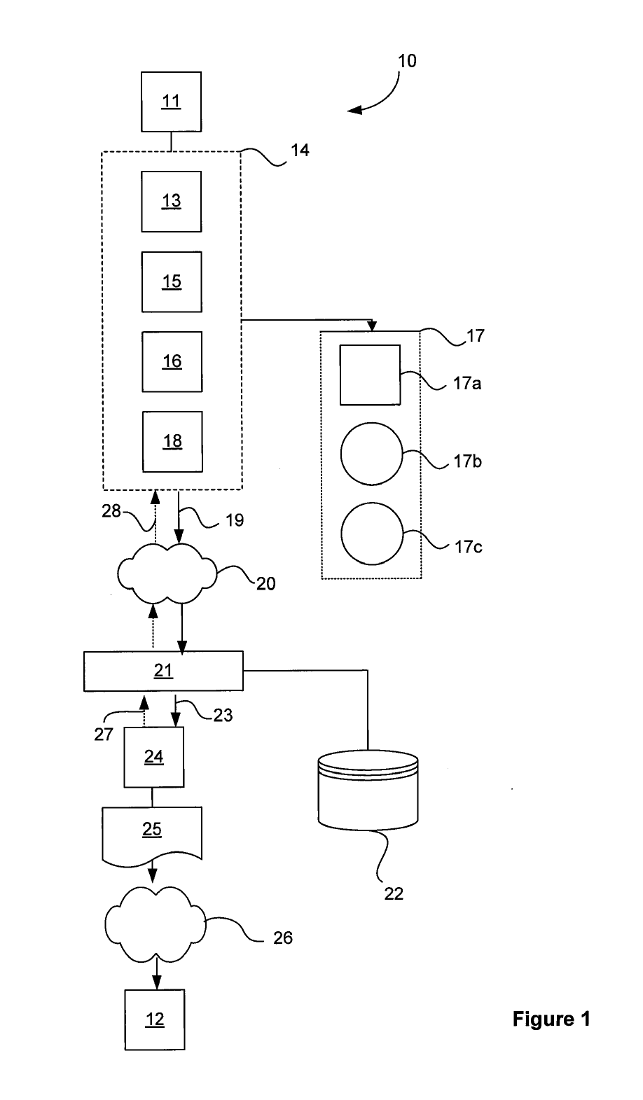

In preferred, but non-limiting embodiments of the present invention, there is provided a method, system, and/or computer readable medium of instructions to facilitate improved delivery of a hardcopy of an application document via a postal network. Preferred embodiments of the present invention are now described with reference to FIGS. 1 to 3.

Referring to FIG. 1, there is illustrated a system 10 for facilitating a sender 11 to post a hardcopy document of an application document to a recipient 12. The application document 13 is created on the client terminal 14 by the sender 11 using a software application. Alternatively, the application document 13 may simply be received on the client terminal 14, being created on a different terminal.

The sender 11 uses software resident on the client terminal 14 to convert the application document 13 into a graphic image file by using an image capture tool 15. Preferably, this image capture tool exists as a printer driver which can be selected from within a standard software program provided with a print function. This produces a graphic image file from the application document, or multiple graphic image files of a multiple page application document.

The automated address checking procedure 16 checks the location of the recipient's address in the graphic image file. The automated address checking procedure 16 can also check that the postal address is valid. The automated address checking procedure 16 determines if there is text in the correct location or uses a preview screen with a mask overlay to determine address field boundaries, or allow the sender to manually inspect the address position. If there is text and the text appears to be a valid address, for example there is a recognisable postcode or suburb name, then the automated address checking procedure 16 can generate a barcode representation of the address and/or look up the address in a postal address file and generate a suitable address representation (eg. barcode) or Delivery Point Identification (DPID) to assist in forwarding the graphic image file to an appropriate printer. If the address is not satisfactory or not valid, the software can prompt the sender 11 to correct the address. In an alternative particular embodiment, the user checks the address location visually using a preview screen with a boundary mask showing the correct location of the address. In a further alternative embodiment, the sender can type in the recipient's address manually or retrieve the recipient's address from an electronic address book database on the terminal.

According to various embodiments of the present invention, the following general steps can be provided:
1. Letters and attachments, as application documents, are captured or generated using a printer driver.
2. The graphic image file produced by the printer driver has a default standard address area, that may or may not correspond to a standard location for the address to be visible through the window of a window envelope. The default standard address area occurs if no previous manual selection has been made.
3. The address location that was last manually selected by the user/sender can be remembered, for example if the application document has the same name or other indicator.
4. The user can overwrite any automatic or previous manual address location selection by manually selecting an address area. This manual selection can occur by the user making a single mouse click, multiple mouse clicks, or drawing or dragging a rectangle around or over all or part of the address.
5. Application documents or graphic image files can be automatically identified and an associated target address can be extracted, even if parts of the address stray outside of a selected address area.
6. Margins in an application document or corresponding graphic image file can be checked to ensure that room is provided for page barcodes, optical mark recognition codes, or other suitable identifiers/codes. If the margins are too small the page image can be automatically, or manually, shifted or reduced to clear the required margin space.
7. The address location/window can be checked to see that it only includes the target or intended address. If the address window is not clear, i.e. it may contain unwanted text or images, a cover page can be added to the graphic image file (i.e. letter to be mailed) with the address located in a correct position on the cover page, for example for correct display of the address through the window of a window envelope. The address location in the cover sheet could be inserted or manipulated as per preceding steps 2, 3 or 4.
8. Optionally, the target address can be analysed to check that it appears to be a correct or valid address. Preferably, but not necessarily, this process occurs on the client terminal, it could occur on the server. The address may be corrected according to local postal standards, for example for format, barcode or DPID. If the address is amended, the new address is then placed in the address window, whether it be a first page of a letter or a cover page as previously discussed. Alternatively, the address can be checked against a database of correct or valid addresses. If the address does not match, an address from the database can be used. The database could reside local or remote to the client terminal.
9. Page barcodes, optical mark recognition codes, or other suitable identifiers/codes, can be added to any or all of the pages of the graphic image file (letter), including any cover sheet.
10. A graphic image file, i.e. letter, once transmitted, can then be sorted according to local postal standards, for example by postcode or suburb, and then printed, folded, inserted into an envelope for entry into the standard physical postal network.

When the recipient's address is satisfactory, the graphic image file is (optionally) compressed and encoded, the client-side software then creates an electronic document 17 which includes the graphic image file 17a, a unique identification number 17b (for tracking the graphic image file or electronic document) and an instruction file 17c. Preferably, but not necessarily, the electronic document 17 is also encrypted and can include a digital signature. Also preferably, but not necessarily, the unique identification number 17b may form part of the instruction file 17c. The instruction file 17c is preferably an XML file containing instructions for the handling of the electronic document 17, for example the instruction file 17c may contain, inter alia:

the unique identification number 17b, used to track the electronic document and for billing purposes;

the sender's account number or details, used for billing and verification purposes, and for the prevention of fraudulent use;

a unique identifier for the client terminal 14, used for tracking and verification of authenticity;

the number of pages or a return email address;

identification numbers for any intermediate resellers, and any individual salespersons, who are involved in a multi-level distribution of the present system, the identification numbers could be used to calculate commissions due to salespersons or sales-teams, for example the intermediate reseller identification numbers can be stored in the database 22 indexed against the sender's account number; and/or

printing instructions, for example colour or black and white, post via express mail, etc.

The electronic document 17 is passed to a queue manager 18 and then electronically transmitted 19 from the client terminal 14 over the computer network 20 to the server computer 21 (which may be a network of computers).

The queue manager 18 can send the electronic document 17 immediately or send several electronic documents in a batch. A server computer message handler receives the electronic document 17, and if required performs decoding/decrypting, verifies the digital signature, and extracts the recipient's address, postcode and/or DPID from the instruction file 17c. Optionally, the server-side software resident on the server 21 can perform further address checking, similar to the automated address checking procedure 16 on the client terminal 14, as an additional checking procedure.

The server-side software can handle incoming electronic documents, check the sender's account status, parse the instruction file associated with an electronic document, decode any encoded format files, decrypt and verify data, extract a recipient's address, track the incoming electronic document, record billing data, handle errors, manage the printing of the hardcopy document, re-encrypt and forward an electronic document to another remote server, or transmit the electronic document using another form of communication.

An electronic document 17 received by the server 21 can be quarantined on the server 21 if a sender's account is not active, for example if the sender has not made previous payments, has no account or has no credit. An electronic notification 28 can be sent to the client terminal 14 alerting the sender 11 to the electronic document 17 having been quarantined.

After verifying the sender's account details, this information is passed to a message forwarder in the server computer 21 which follows a set of rules to decide which is a suitable mail distribution centre printer to receive the graphic image file 17a, for example which is the closest mail distribution centre printer to the recipient's address. Information concerning the receipt or transmittal of electronic documents, graphic image files or any other information relating to the transaction, for example data from the instruction file 17c, can be recorded in the database 22.

The graphic image file 17a is electronically transmitted 23 to the selected printer/printer server 24, and the server 21 records the transaction in the database 22, which can be indexed by the unique identification number 17b.

The printer/printer server 24 sends an electronic notification message 27 back to the server computer 21 detailing the results of the printing operation. On receipt of the electronic notification message 27, the server-side software updates the database 22 and, either automatically or if requested (i.e. optionally), forwards a further electronic notification message 28 to the client terminal 14 so as to inform the sender 11 of the success, or otherwise, of the delivery of the hardcopy document 25 into the postal network 26. The electronic notification message 28 could also be initially either automatically or if requested (i.e. optionally), transmitted to the client terminal 14 to confirm receipt of the electronic document 17 by the server 21.

In an alternate embodiment of the invention, the complete electronic document 17 could be sent to the printer server. If the complete electronic document 17 is transmitted, the electronic document 17 is received by the printer server's message handler, which, if required, decodes the electronic document 17 and sends the graphic image file 17a to it's local printer.

The resulting hardcopy document 25 is inserted into an envelope to form a letter which is then submitted into the postal network 26 for distribution to the recipient's address, and thus the recipient 12, via the postal network 26. The formation of the letter could be an automated process performed at the mail distribution centre.

In a further possible embodiment, server-side software resident on the server 21 reads the recipient's address and generates a suitable barcode or DPID, or uses a barcode or DPID generated at the client terminal 14, so as to add the barcode or DPID to the hardcopy document 25 or the envelope for faster, cheaper or more efficient delivery via the postal network 26.

In a further embodiment of the present invention, the splitting of mail merges into individual letters is provided. A mail merge is a set of similar documents generated on a computer and intended for multiple recipients. It is normally sent to a printer as a single document print job and the user then is required to manually sort the printed hardcopy pages for each recipient. Therefore, if the mail merge is a two-page document to one hundred recipients, it is sent to the printer as a single two hundred page document. The system of the present invention uses special codes at the end and/or beginning of a mail merge template to establish the start and the end of each individual document and can therefore break-up a two hundred page single document into the one hundred separate two-page documents. This therefore allows the system to automatically process the documents on the server without human intervention. If this was not the case, it would be required to manually process/sort the documents before posting, or the first recipient would receive all the merged documents in the post. This allows the mail merge to be performed on the client terminal 14 rather than the server 21. This same principle applies to any job where multiple letters are sent to the printer as one job, i.e. end of month statement runs, etc. Alternatively, the entire mail merge job can be sent as a whole and the processing into separate documents is carried out by software on the server.

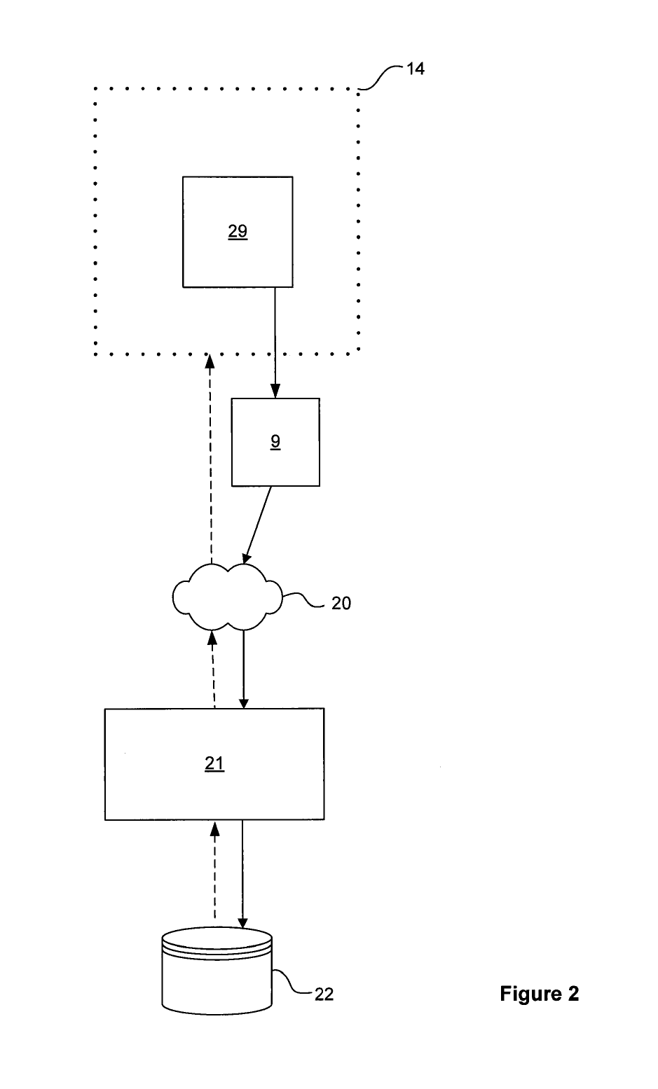

Referring to FIG. 2, the sender 11 can use a document manager 29 on the client terminal 14 to view a summary of all electronic documents sent and their status. The document manager 29 can also be used to preview any electronic documents or graphic image files sent to the server 21. The document manager 29 transmits a query 9 to the server 21 via computer network 20. This results in a query of the database 22 for the most recent status, for example a status could relate to an electronic document or graphic image file being queued, sent, received, printed, posted, failed, etc. Also preferably, there is provided a local client-side database or file record which is regularly updated whenever the database 22 is queried.

In another embodiment, access to the status of delivery of documents can be provided by allowing a sender 11 to log into the server 21 via a web browser and query the status of electronic or hardcopy documents by using the unique identification number and an account number and password.

In a further alternative embodiment, a mail distribution centre, for example a local post office, prints the graphic image file 17a. This ensures that the first time the hardcopy document 25 enters the postal network the hardcopy document 25 is free from dangerous biological or chemical agents, or other hazardous material. This procedure also ensures that the hardcopy document 25 is “least cost” routed by electronic means to a physical printing point closest or close to the recipient's address, and not the sender. That is, physical transportation costs associated with hardcopy documents are reduced.

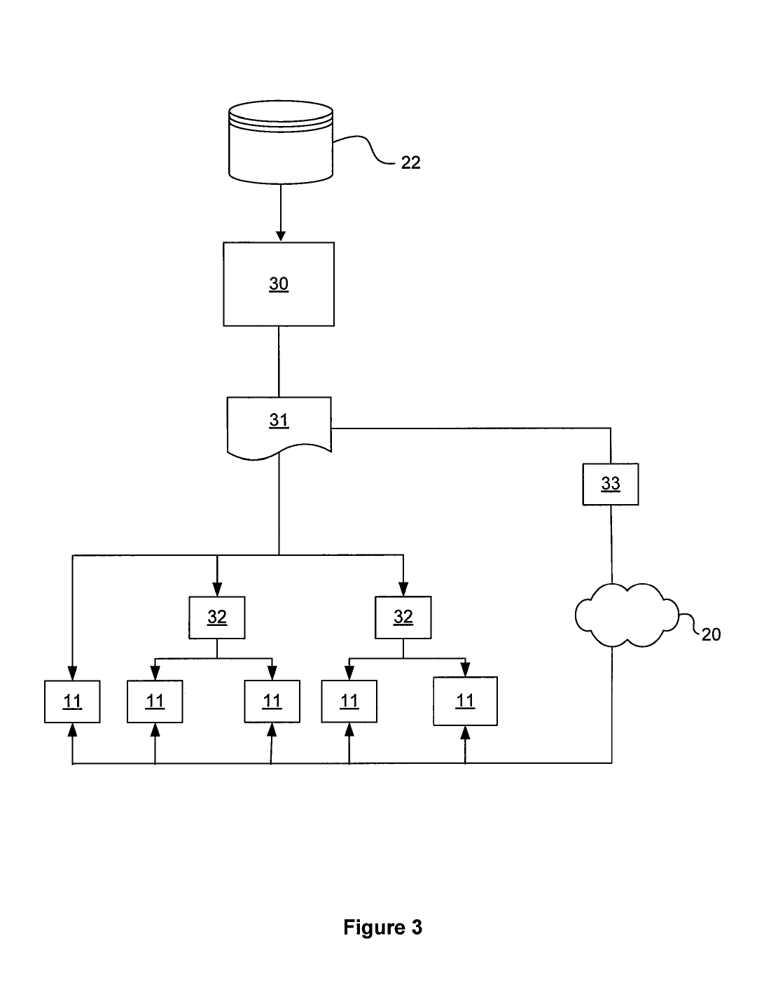

According to a further aspect of an embodiment of the present invention, and referring to FIG. 3, a billing system 30 is shown that can periodically, for example monthly, retrieve information from the database 22 to produce an invoice 31 of charges accrued for each sender 11, or for any intermediate resellers 32 offering the system or method of the present invention. The billing system 30 can also produce a periodic, for example daily, journal 33 of transactions for each sender 11. If requested, the journal 33 may be transmitted to each sender 11 via the computer network 20. This allows an intermediary payment structure to be set-up for allocating commission payments to various parties.

Virtual Letterhead

According to a further aspect, there is provided a “virtual letterhead”. In one form, users may elect to print one or more letters in a single print stream using image capture tool 15, for example which can be provided as a selectable specific printer. In this form, content that needs to be repeated for each letter (eg. logo, return address, contact information, disclaimers, etc.) must be included in the original print steam. This makes the original print stream larger than necessary thereby causing processing delays (eg. the letters take longer to print and to analyse). In some cases, users may have existing application documents 13 that were designed to be printed on a page of paper provided with a pre-printed letterhead. It may not be cost effective for these users to change the legacy applications that generate such letters.

In an enhanced form, users are able to print a letterhead or the like using image capture tool 15, for example a printer driver, and save the letterhead as a “virtual letterhead”. Users would then be able to select one or more virtual letterheads to be used with one or more letters. Furthermore, a user's letterhead might be split up into composite parts, for example one set for the headers and another for the footers. The virtual letterhead, or composite parts thereof, could be applied to letters using the following rules:

1. If the letterhead consists of a single page, then the letterhead would be printed on the first page of each letter.

2. If the letterhead consists of n pages (where n is greater than 1), then the first n−1 pages of the letterhead would be printed on the first n−1 pages of each letter. The last page of the letterhead could then be printed on all of the remaining pages of each letter.

With respect to printing a page of the letterhead on a page of the letter, the letterhead would preferably be rendered first and then the corresponding page of the letter (to simulate the process of printing the letter to traditional letterhead).

A virtual letterhead would be associated with a specific document ID (unique GUID). If the document ID is not recognised on server 21, the letter could be printed on plain paper. For large customers, server 21 could be set-up to divert letters that included a specific document ID to be printed on an actual hardcopy letterhead (quicker and less costly). In the alternative, printer(s)/printer server(s) 24 could be pre-loaded with the softcopy virtual letterhead and server 21 and/or printer(s)/printer server(s) 24 could substitute specific document ID's with the appropriate printer commands to render the softcopy virtual letterhead, for example using PPML. Alternatively, the softcopy virtual letterhead could be passed to the printer(s)/printer server(s) 24 at the same time as the actual print stream.

In a particular method embodiment for printing a hardcopy document with a letterhead, the method includes, at the server, receiving the electronic document from the terminal. The electronic document includes at least the graphic image file and the document ID, the document ID being associated with a particular letterhead and the graphic image file having been obtained from an application document. A document ID may be unique to each unique instance of a letterhead, but a document ID can be reused when a letterhead is required again. The graphic image file is transmitted to the printer server to be printed with the letterhead as the hardcopy document by the printer, the letterhead having been obtained or retrieved using the document ID.

The letterhead can be obtained or retrieved in a variety of ways, for example the letterhead can be obtained from the database and transmitted to the printer server with the graphic image file. Alternatively, the letterhead can be obtained from the database and transmitted to the printer server separately to the graphic image file. Also alternatively, the letterhead can be obtained from a memory associated with the printer or the printer server, eg. a local or internal hard disk or solid state memory.

A user is preferably provided with a selectable option at the terminal so as to be able to select one of a plurality of letterheads for printing, which produces the document ID. For example, the user could select a specific letterhead prior to printing or have previously selected a default letterhead. In another form, the letterhead can include composite parts. A user can be provided with a further option at the terminal to simply select all of a letterhead, or only part or parts of the letterhead, eg. only a logo or a header section, for printing.

In a particular example, the instruction file may contain the document ID. The instruction file may also still contain the unique identification number or any other required or useful information. In one possible form, the document ID (GUID) could be the same as the unique identification number, although this is not essential and may not be preferable.

Silent Send

According to a still further aspect, there is provided a “silent send” mode. In one form, users print one or more letters in a single print stream to the image capture tool 15, for example a printer driver. Users may preview their letters, select attachments and/or virtual letterhead, and then submit their letters. However, in this form, there is no provision of any function for attachments, virtual letterhead, physical inserts, envelope stock, etc., to be automatically used with submitted letters.

In an enhanced form with “silent send” mode, letters are automatically submitted for production with no further user intervention. A user selectable option can be provided to enable the user to simply and readily select a resource for a printing job. For example, the user selectable option may be a wildcard string. Lists of wildcard strings can be associated with an attachment, physical insert, virtual letterhead, a type of physical paper (eg. with a hardcopy letterhead already present or a size of paper), a type of envelope, etc., (herein referred to as “resources”). When a new set of letters is printed to image capture tool 15, for example a printer driver, the name (or other identifier) for the new print stream can be compared with the wildcard strings associated with each available resource. For every match found, the corresponding resource would be added to the original letters. In a standard mode, this would save the user several steps as the letters would automatically include required resources. This would also allow for features such as attachments and virtual letterhead to be used for letters printed using the “silent send” mode.

The document ID and/or the wildcard string can be utilised to cause the graphic image file, when printed, to be selectively associated with the resource, which may have been preprinted. That is, the user can select a virtual resource, such as an attachment or physical insert, which is then physically used with a printed graphic image file. For example, the resource could be a preprinted attachment or physical insert which is associated with the printed graphic image file by both the printed graphic image file and the attachment or physical insert being inserted in an envelope together for mailing.

Additionally, the following example characteristics/features could also be controlled by using wildcards:

1. Colourmode (colour of B&W);

2. Simplex/duplex;

3. Ignore first page;

4. Department (billing codes);

5. Email Address (contact information); and/or

6. Return address.

Ignore Page

According to a still further aspect, there is provided an “ignore page” command or function. In one form, users print one or more letters in a single print stream to the image capture tool 15, for example a printer driver. The first page of each letter should include a delivery address. The delivery address is then extracted from each letter. If a user wishes to send a standard (not personalised) brochure or document to a distribution list, the user must add the delivery addresses to the brochure (which may be white on white, that is not visible to the recipient). This process requires that the user modifies their standard brochure and print a large print stream (since the entire brochure must be printed for each recipient).

Another problem with this form is that it is difficult or problematic to use with many document imaging systems. Many document imaging systems store documents as images (eg. TIFF). Although such documents may be printed to the image capture tool 15, for example a printer driver, software resident on server 21 may not be able to extract the delivery addresses because they are not included in the print stream as text. Although the delivery address is known by the document imaging system, there is no way to pass this information to server 21.

In an enhanced form, the user is able to specify that a page of each letter is to be ignored, preferably, for example, the first page of each letter is to be ignored (not printed) except for address extraction. Using this enhancement, users could print a standard brochure or other document as an attachment (only printed once) and then create a simple mail-merge from their distribution list. Such a mail-merge could include nothing but the delivery addresses. This would greatly simplify (and reduce resources required including disk storage and network bandwidth) the process of mailing of standard brochures or other documents. The recipient's address may be extracted from the graphic image file at the server or at the printer server.

This enhanced form would also facilitate the use of system 10 with document imaging systems. The document imaging systems could be modified to print a trivial cover page with a delivery address for each letter. These trivial cover pages would be used to extract the delivery address but otherwise be ignored.

Consolidation of Application Documents

In the system disclosed in U.S. application Ser. No. 11/099,205, a software application prints one or more letters in a single print job. A user is then able to parse the print stream to determine where the letters start and end. After the user has reviewed the letters, they may be submitted together to a server. In some situations, software applications (for example MYOB, FASTRACK, etc.) have been designed to print letters individually. Although such letters can be submitted for processing, the additional time and actions required to open, review and submit each letter individually makes the use of the system uneconomical. Attempts to merge the letters before submission to the server have proved ineffective because the separate letters can often use different embedded fonts and other elements. These differences make it very difficult to separate the letters in such a merged print stream.

According to a particular aspect of the present invention, there is provided a means for “consolidation or concatenation of application documents”. An arbitrary number of print streams may be concatenated or consolidated into a single job as a virtual print stream for submission to the server. This can dramatically reduce the time it takes for some users to submit mail. In one form, the steps are as follows:

1. The print driver is set to print the application documents without initiating submission to the server;

2. The user “prints” a series of application documents (as would normally be done to a local printer);

3. The user opens an application, for example a “Mailroom” application, and/or navigates to a specific folder or virtual folder being a collection of objects in different locations, for example called a “New” folder or virtual folder;

4. The “New” folder or virtual folder contains all of the graphic image files (e.g. letters in WYSIWYG form as previously described) obtained from the application documents to be printed by a remote printer;

5. The user selects all (or a subset) of the graphic image files in the “New” folder or virtual folder;

6. The selected graphic image files can then be concatenated/consolidated into one virtual print stream;

7. The user can then review and submit the selected graphic image files to the server for subsequent printing using the same tools that would have been used had each application document been printed separately as single print streams.

In another form, a user is not required to review/open the “Mailroom” application or the “New” folder or virtual folder. By associating a timer with the “New” folder or virtual folder all graphic image files (or the application documents from which they are derived) that match a certain description or condition can be automatically or semi-automatically uploaded/submitted periodically, for example by setting a timing parameter to upload the files every x minutes/hours. As a specific illustrative example, all graphic image files starting with “Invoice*.*” could be aggregated and uploaded every 30 minutes, but graphic image files starting with “Statement*.*” could be uploaded every 240 minutes.

Internally, the application documents are kept separate so that different fonts and other elements within the application documents do not cause parsing errors. In fact, application documents with completely different structures and formats could be concatenated/consolidated in this manner. Preferably, a pre-requisite for such concatenation or consolidation is that the address for all the application documents is in roughly the same location (e.g. a user should be able to draw a rectangle that could contain the addresses for all the application documents but no other blocks of text that could be mistaken as part of an address).

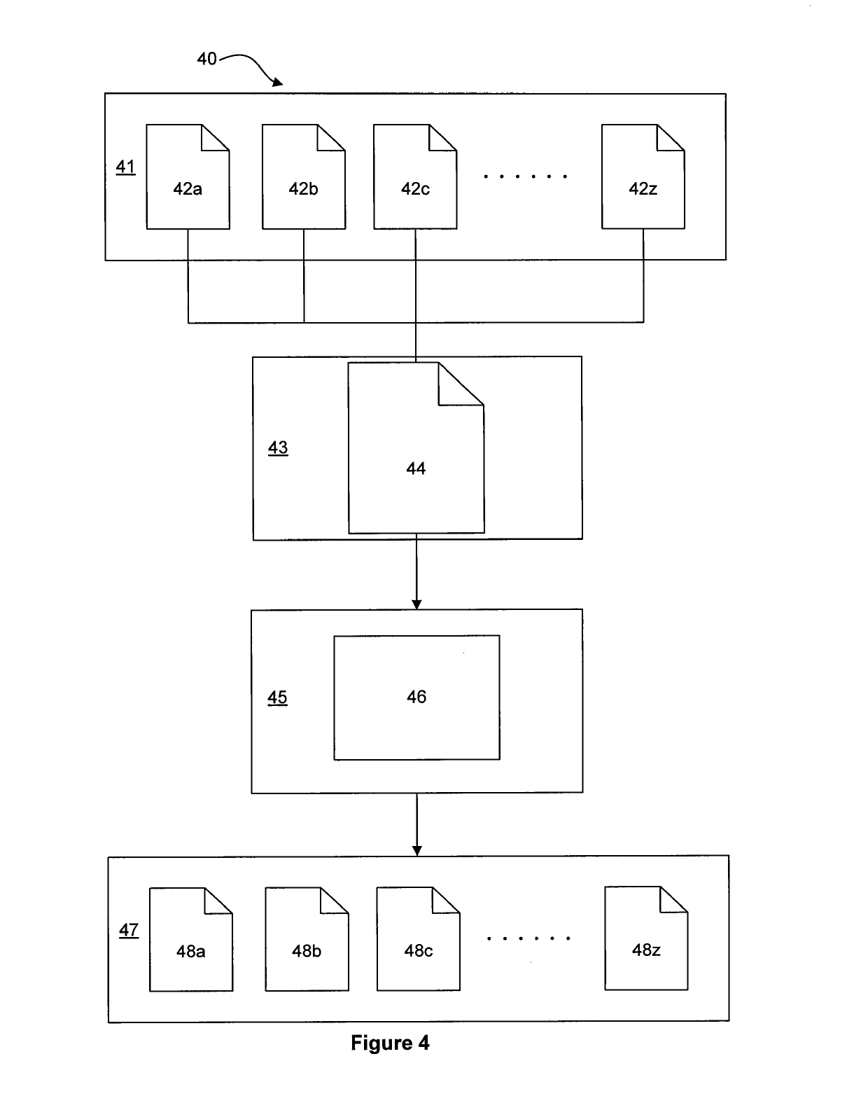

Referring to FIG. 4, there is illustrated a method 40 of printing a plurality of application documents in a virtual print stream. Method 40 includes step 41 of producing a plurality of graphic image files 42a, 42b, 42c . . . 42z, each graphic image file 42a, 42b, 42c . . . 42z obtained from an application document. At step 43 more than one of the plurality of graphic image files are concatenated into a concatenated graphic image file 44, being at least part of a virtual print stream, wherein each of the graphic image files forming part of the concatenated graphic image file 44 are distinct within the concatenated graphic image file 44. Preferably, a user can open and view the concatenated graphic image file 44 as a single file. At step 45, an electronic document 46 is produced, the electronic document 46 including at least the virtual print stream. At step 47, the electronic document is transmitted to a processing system for subsequent printing of the more than one of the plurality of graphic image files as hardcopy documents 48a, 48b, 48c . . . 48z by at least one printer.

It should be noted that a possible feature of the graphic image files being kept separate within the virtual print stream is not an essential feature of the invention. In one form, an optimization routine is provided that can search through all of the graphic images in a virtual print stream, identify common elements (identical images such as bitmaps, sections of text, fonts, etc.) and restructure the virtual print stream so that a single occurrence of each common element is kept and inserted where required when the print stream is played/printed. This could substantially reduce the amount of disk space required for the storage of the virtual print stream. Also, in another form, the virtual print stream may be viewed by the end user as a single logical print stream. The internal separation of the graphic image files is preferred but not necessarily essential.

### DETAILED SPECIFIC EMBODIMENT

The following example provides a more detailed description of one particular embodiment. This example is intended to be merely illustrative and not limiting to the scope of the present invention.

An embodiment of the present invention uses a computer program that runs on the sender's computer. The computer program consists of software written in the C programming language to run on the Microsoft Windows 32-bit operating system (WIN32) together with a custom printer driver developed using the Microsoft Windows Driver Development Kit (DDK).

After the sender has created or received an application document on their WIN32 computer terminal, the sender selects a custom printer driver which “prints” the application document by saving the application document as a series of Postscript, Portable Document Format (PDF), Printer Command Language (PCL) or Enhanced Metafile Format (EMF) files on the terminal's storage medium. The printer driver then, in turn, initiates the client-side software. The software displays the Postscript, PDF, PCL or EMF files in WYSIWYG format on the sender's (i.e. user's) computer screen with the relevant area for the correct location of the postal address highlighted. Thus the sender can tell by inspection that the recipient's address is in the correct location and can instruct the software to send an electronic document or cancel the operation. In an alternative embodiment, the software automatically examines the Postscript, PDF, PCL or EMF file for graphical text elements in the relevant area of the page and then analyses this text according to pre-programmed rules to ascertain whether the document contains a valid postal address.

The Postscript, PDF, PCL or EMF files are then digitally compressed using the ZLIB compression algorithm as specified in RFC1950 “ZLIB Compressed Data Format Specification version 3.3” (P. Deutsch and J-L Gailly, May 1996) and are then encoded using Basic Encoding Rules (BER) in accordance with ITU-T Recommendations X.690-X.691 (2002) and CCITT Recommendation X.209.

The software generates a unique identification number by using Windows internal software that creates a global unique identifier (GUID), a bit string guaranteed to be unique to a very high degree of certainty. This number is encoded in base 24 format and is used as a reference to the message in all subsequent stages, and also as key in a local database of messages maintained by the software on the sender's local terminal.

The software then generates an instruction file in Extensible Markup Language (XML) containing instructions for this particular message including the unique identification number, sender's account details, number of pages, return email address, and so forth. This XML instruction file is combined with the BER-encoded Postscript, PDF, PCL or EMF files and converted into a Secure Multipurpose Internet Mail Extensions (S/MIME) message using public key encryption in accordance with RFC2633 “S/MIME Version 3 Message Specification” (B. Ramsdell, June 1999) and RFC2630 “Cryptographic Message Syntax” (R. Housley, June 1999).

The software then opens a Transmission Control Protocol/Internet Protocol (TCP/IP) connection with the server computer over the Internet and sends the S/MIME message to the server, for example using the HyperText Transfer Protocol (HTTP) or Simple Mail Transfer Protocol (SMTP) as per RFC821. The message can also be encrypted prior to being sent using, for example, HTTP or SMTP. The message transmission is independent of any email client applications that may exist on the sender's terminal. Alternatively, the software stores the information in a queue so the message can be sent by HTTP or SMTP transmission at a later time. After transmission, the software stores the result (success or failure) in the local database.

When the sender uses a Document Manager to query the status of documents, the software looks up the local database for the identifiers of any outstanding documents. It then sends a request on these outstanding documents to the server computer using Hypertext Transfer Protocol (HTTP) commands and receives back the latest status details (received, being printed, successfully posted, rejected, not found, etc.). The software then updates the local database with this information and displays the results to the user in a Graphical User Interface (GUI).

Thus there has been provided a method, system, computer program product and/or computer readable medium of instructions to facilitate the delivery of a hardcopy document, obtained from an application document, into a postal network.

The invention may also be said broadly to consist in the parts, elements and features referred to or indicated in the specification of the application, individually or collectively, in any or all combinations of two or more of said parts, elements or features, and where specific integers are mentioned herein which have known equivalents in the art to which the invention relates, such known equivalents are deemed to be incorporated herein as if individually set forth.

Although the preferred embodiment has been described in detail, it should be understood that various changes, substitutions, and alterations can be made herein by one of ordinary skill in the art without departing from the spirit or scope of the present invention.

The present invention may take the form of an entirely hardware embodiment, an entirely software embodiment, or an embodiment combining software and hardware aspects.

1. A method of printing a plurality of application documents in a virtual print stream, the method including, at a terminal, the steps of:
producing a plurality of graphic image files, each graphic image file obtained from an application document;
concatenating more than one of the plurality of graphic image files into a concatenated graphic image file being at least part of a virtual print stream, wherein a user can open and view the concatenated graphic image file as a single file;
producing an electronic document, the electronic document including at least the virtual print stream; and,
transmitting the electronic document to a processing system for subsequent printing of the more than one of the plurality of graphic image files as hardcopy documents by at least one printer.

2. The method as claimed in claim 1, wherein the plurality of graphic image files are located in a specified folder or virtual folder.

3. The method as claimed in claim 2, wherein the specified folder or virtual folder is associated with a timer.

4. The method as claimed in claim 1, wherein when a selected time has elapsed at least one of the plurality of graphic image files is automatically transmitted to the processing system.

5. The method as claimed in claim 1, wherein when a specified condition has occurred at least one of the plurality of graphic image files is automatically transmitted to the processing system.

6. The method as claimed in claim 1, wherein the user can selectively choose which of the plurality of graphic image files are to form the concatenated graphic image file.

7. The method as claimed in claim 1, wherein the user can move the location of address information in one or more of the plurality of graphic image files.

8. The method as claimed in claim 1, wherein the user can select the location of address information in one or more of the plurality of graphic image files.

9. The method as claimed in claim 1, wherein the virtual print stream is routed to a particular printer for printing based on a recipient's address information in a graphic image file.

10. The method as claimed in claim 1, wherein the electronic document includes an instruction file containing printing instructions.

11. The method as claimed in claim 10, wherein the instruction file contains a unique identification number.

12. The method as claimed in claim 11, wherein a representation of the unique identification number is printed on the hardcopy document.

13. The method as claimed in claim 1, wherein each of the graphic image files forming part of the concatenated graphic image file are distinct within the concatenated graphic image file.

14. A method of consolidating a plurality of application documents into a virtual print stream for printing of hardcopy documents, obtained from the plurality of application documents, and submission into a postal network, the method including:
a plurality of application documents being created on, or sent to, a client terminal;
software resident on the client terminal generating a plurality of graphic image files, each graphic image file obtained from an application document, at least one graphic image file including a recipient's address, and at least one graphic image file being allocated a unique identification number;
concatenating more than one of the plurality of graphic image files into a concatenated graphic image file being at least part of a virtual print stream, wherein a user can open and view the concatenated graphic image file;
an electronic document being generated which includes at least the virtual print stream and the unique identification number;
the electronic document being transmitted over a computer network to a server; and,
software resident on the server receiving the electronic document and forwarding the virtual print stream to be printed by a printer for subsequent entry of the printed hardcopy documents into the postal network for physical delivery to at least one recipient's address.

15. A system for consolidating a plurality of application documents into a virtual print stream for printing, the system including:
a server for receiving an electronic document from a terminal, the electronic document including at least a virtual print stream, the virtual print stream having been produced from a plurality of graphic image files, each graphic image file obtained from an application document, wherein the plurality of graphic image files are concatenated in a concatenated graphic image file being at least part of the virtual print stream, wherein a user can open and view the concatenated graphic image file; and,
a printer server for receiving the virtual print stream to be printed as hardcopy documents by at least one printer.

16. The system as claimed in claim 15, wherein printing the plurality of application documents is effected by selecting a printer driver at the terminal.

17. The system as claimed in claim 15, wherein each of the graphic image files forming part of the concatenated graphic image file are distinct within the concatenated graphic image file.

18. A computer program product for consolidating a plurality of application documents into a virtual print stream for printing, the computer program product configured to:
produce a plurality of graphic image files, each graphic image file obtained from an application document;
concatenate more than one of the plurality of graphic image files into a concatenated graphic image file being at least part of a virtual print stream, wherein a user can open and view the concatenated graphic image file;
produce an electronic document, the electronic document including at least the virtual print stream; and,
transmit the electronic document to a processing system for subsequent printing of each graphic image file as a hardcopy document by at least one printer.

19. The computer program product as claimed in claim 18, wherein each of the graphic image files forming part of the concatenated graphic image file are distinct within the concatenated graphic image file.
